(19) United States
(12) Patent Application Publication
(10) Pub. No.: US 2024/0308233 A1
(43) Pub. Date: Sep. 19, 2024

(54) COLORANT COMPENSATION USING RELATIVE COLORANT VOLUMES

(71) Applicant: Hewlett-Packard Development Company, L.P., Spring, TX (US)

(72) Inventors: Jan Morovic, London (GB); Peter Morovic, Sant Cugat del Valles (ES)

(73) Assignee: Hewlett-Packard Development Company, L.P., Spring, TX (US)

(21) Appl. No.: 18/185,927

(22) Filed: Mar. 17, 2023

(51) Int. Cl. B41J 2/21; G01J 3/02

(52) U.S. Cl. CPC B41J 2/2107; G01J 3/027; G01J 3/0291; G01J 2003/2836; G01J 2003/2859

(57) ABSTRACT

In example implementations, a method is provided. The method determines relative colorant volumes to colorimetry relationship of first substrate at first time. Determine relative colorant volumes to colorimetry relationship of first substrate at second time as function of relative colorant volumes to colorimetry relationship of first substrate at first time. Determine ratio of relative colorant volumes of first substrate at first time and second time. Determine relative colorant volumes to colorimetry relationship of second substrate at third time as function of ratio of relative colorant volumes of first substrate. Determine relative colorant volumes to colorimetry relationship of second substrate at fourth time as function of relative colorant volumes to colorimetry relationship of second substrate at third time. Compensate colorant drift on second substrate based on difference between relative colorant volumes to colorimetry relationship of second substrate at third time and fourth time. Compensate colorant drift on the first substrate.

### BACKGROUND

A colorant calibration method performs colorant calibration of each colorant of a printer for each substrate type used in the printer. That is, each colorant is calibrated on each substrate type used in the printer.

### BRIEF DESCRIPTION OF THE DRAWINGS

FIG. 1 is a block diagram of an example colorant compensation method of the present disclosure for a first substrate;

FIG. 2 is a block diagram of an example colorant compensation method of the present disclosure for a second substrate;

FIG. 3 is a block diagram of an example of a method of the present disclosure of transferring colorant compensation information from one substrate to another substrate;

FIG. 4 is a flow chart of an example colorant compensation method of the present disclosure; and

FIG. 5 is a schematic of a colorant compensation system of the present disclosure.

### DETAILED DESCRIPTION

Examples described herein provide a device for and a method of colorant compensation that enables consistent color output from a printer over time by determining if there is a change of a colorant volume for a desired colorant than when the printer was initially calibrated and compensating for the change in colorant volume by adjusting the colorant volume to output the same color as was output by the printer when initially calibrated.

Examples described herein provide a device for and a method of colorant compensation for a plurality of different substrate types based on a characteristic measurement on one substrate type, which eliminates the need to perform a calibration method on each substrate type.

Examples described herein also enable characterization of a colorimetry to relative colorant volume relationship (e.g., a non-linear colorimetry to relative colorant volume relationship) for one substrate type without having to know an exact volume of colorant to produce a color, which enables colorant compensation of other substrate types (e.g., cross-colorant compensation) without having to determine a colorimetry to colorant volume relationship for each substrate type.

Examples described herein provide colorant volume continuity and traceability across multiple substrate types without having to change a substrate in a printer.

A printhead of a printer may output a different volume of colorant than another printhead. In addition, after a printhead has printed for an amount of time, the volume of colorant the printhead outputs for the same desired color may decline, which results in an undesired color. As a result, a volume of colorant output by a particular printhead at a particular time may be unknown. Thus, maintaining printer colorant output consistency over time may require knowledge of printhead output colorant volume in order to compensate for deviations from a desired color when a printer is initially calibrated. Furthermore, a certain volume of colorant may result in different colors when deposited on different types of substrates (e.g., vinyl, wallpaper, etc.).

An understanding of a colorimetry to colorant volume relationship of a substrate and an colorant volume for which the relationship holds may be required to determine what change in colorant volume would compensate for a deviation from a desired color when a printer was initially calibrated and change the colorant volume output of the printer for the desired color for other substrate types used by the printer. Thus, examples described herein may use one substrate type to determine how to compensate for deviations in color of multiple substrate types without requiring loading of another substrate type, printing on another substrate type, or measuring another substrate type.

Knowledge of a colorimetry to colorant volume relationship and an indication of colorant volume output by a printhead are required to use measurements from one substrate to correct for a deviation from an initial calibration of multiple substrates.

A method of calibration may perform calibration on a number of substrate types without distinguishing between a change in colorant volume and a color output by the change in colorant volume. That is, printing a colorant gradation chart (e.g., colorant patches) for each colorant, measuring the colorants on each chart, and comparing the measurements to reference measurements on similar colorant gradation charts produced either during development of the printer or when a substrate was first used in the printer. Based on the comparison, adjustments are made to the printer in order for the printer to reproduce the original colorant gradation charts. This method, which looks at a combined effect of variation in colorant volume and color output, may be time consuming and resource intensive.

Examples described herein determine a change (e.g., a percentage change) in colorant volume from when a printer was initially calibrated to when the printer has been operated for a while. Examples described herein do not require an actual value of colorant volume when the printer is initially calibrated or after the printer has operated for a while. In addition, any substrate may be used as a reference for determining a change in colorant volume output over time. For example, the reference may be a first substrate initially loaded into a printer or a second substrate loaded into the printer at a subsequent time. The reference may then be used to relate changes in colorant volume output to another substrate subsequently loaded into the printer.

Examples described herein perform colorant compensation on each colorant used in a printer, where the same colorant compensation method may be performed using each colorant individually.

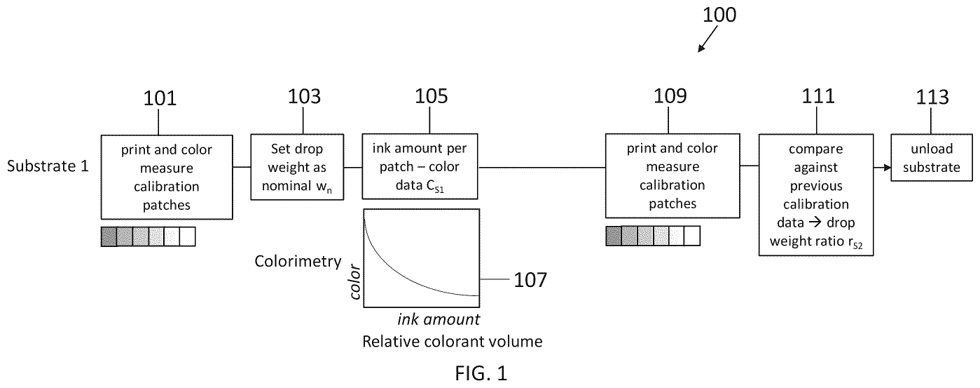

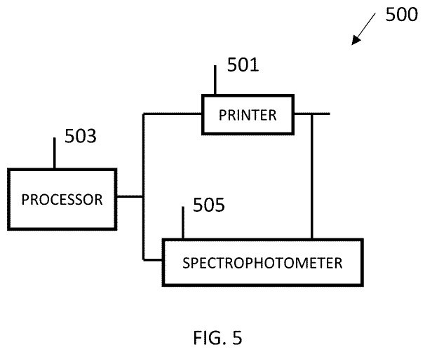

FIG. 1 illustrates a block diagram of an example colorant compensation method 100 of the present disclosure for a first substrate (e.g., Substrate S1). In an example, the method 100 may be performed by a colorant compensation system 500 including a printer 501, a spectrophotometer 505, and a processor 503 illustrated in FIG. 5 and described below in greater detail.

At block 101, the method 100 begins. At block 101, the first substrate (e.g., Substrate 1) is loaded into a printer, a colorant to be compensated is selected, a plurality of first patches is printed in the selected colorant at a first time T₁, and the plurality of first patches are measured.

At block 103, the method 100 sets a nominal colorant volume wₙ (also commonly referred to as an ink drop weight) indicating an amount of colorant on each of the plurality of first patches. In an example, the measurement may be of lightness (e.g., using the CIELAB color space defined by the International Commission on Illumination (abbreviated CIE). The CIE L* color space may be used to measure the lightness of most ink colors. The CIE b* color space may be used to measure the lightness of yellow ink. The spectrophotometer 505 may be used to measure an optical characteristic of each patch.

At block 105, the method 100 generates compensation data C_{S1} for Substrate 1. The compensation data may be pairs of corresponding colorimetry and relative colorant volume values. In an example, the compensation data C_{S1} may be a graph of colorimetry versus relative colorant volume as illustrated in block 107, where the graph is one example of how to visualize the compensation data C_{S1}.

At block 109, the method 100, at a second time T₂, positions a second instance of Substrate 1 in the printer, prints second patches in the selected colorant, and measures the second patches. In an example, T₂ is a time at which the printer may print a color with a drift in color as compared to time T₁.

At block 111, the method 100 compares the measurements of the second color patches of the second instance of the first substrate (e.g., Substrate 1) to the calibration data C_{S1} of the first substrate and determines a relative colorant volume ratio r_{S2}.

At block 113, the method 100 unloads the first substrate from the printer.

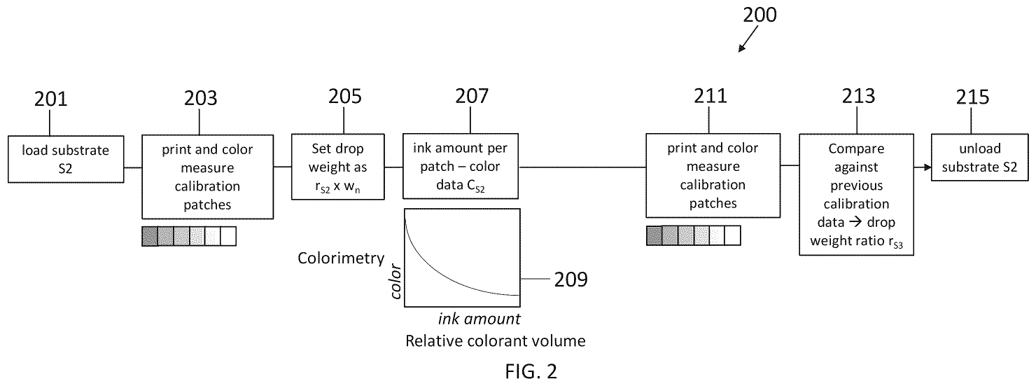

FIG. 2 is a block diagram of an example colorant compensation method 200 of the present disclosure for a second substrate S2. In an example, the method 200 may be performed by the colorant compensation system 500 including the printer 501, the spectrophotometer 505, and the processor 503 illustrated in FIG. 5 and described below in greater detail.

At block 201, the method 200 begins. At block 201, the second substrate (e.g., S2) is loaded into the printer used in the method 100 in FIG. 1.

At block 203, the method 200 prints a plurality of third patches in the colorant selected in the method 100 in FIG. 1 at a third time T₃ and the plurality of third patches are measured. In an example, the measurement may be of lightness (e.g., using the CIELAB color space defined by CIE. The CIE L* color space may be used to measure the lightness of most ink colors. The CIE b* color space may be used to measure the lightness of yellow ink. The spectrophotometer 505 may be used to measure an optical characteristic of each patch printed on the second substrate S2.

At block 205, the method 200 sets a relative colorant volume of the plurality of third patches as r_{S2} times wₙ.

At block 207, the method 200 generates compensation data C_{S2} for the second substrate S2. The compensation data may be pairs of corresponding colorimetry and relative colorant volume values. In an example, the calibration data C_{S2} may be a graph of colorimetry versus relative colorant volume as illustrated in block 209, where the graph is one example of how to visualize the compensation data C_{S2}.

At block 211, the method 100, at a fourth time T₄, positions a second instance of the second substrate S2 in the printer, prints fourth patches in the selected colorant, and measures the fourth patches. In an example, T₄ is a time at which the printer may print a colorant with a drift as compared to time T₃.

At block 213, the method 200 compares the measurements of the fourth patches to the calibration data C_{S2} of the second substrate S2 and determines a relative colorant volume ratio r_{S3}. In an example, a relative colorant volume of the plurality of fourth patches is r_{S3} times the relative colorant volumes wₙ of the third patches of the second substrate. Since the relative colorant volume of the third patches of second substrate is r_{S2} times the relative colorant volumes wₙ of the first patches of the first substrate (e.g., the nominal colorant volumes of the first patches), r_{S3} times the relative colorant volumes wₙ of the third patches of the second substrate is equal to r_{S3} times (r_{S2} times wₙ of the first substrate), and so on for further substrate types used in the printer. Thus, the relative colorant volumes of different substrate types are related, or linked, to each other and a relative colorant volume for any of the substrates may be used to compensate for color drift on any of the substrates without having to spend additional resources and time reloading substrates and printing additional patches.

At block 215, the method 200 unloads the second substrate S2 from the printer.

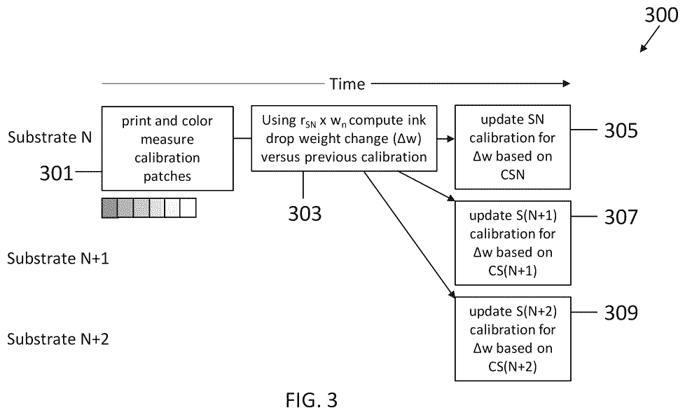

FIG. 3 illustrates a block diagram of an example of a method 300 of the present disclosure of transferring colorant compensation information from one substrate to another substrate. In an example, the method 300 may be performed by the colorant compensation system 500 including the printer 501, the spectrophotometer 505, and the processor 503 illustrated in FIG. 5 and described below in greater detail.

At block 301, the method 300 begins. At block 301, a substrate (e.g., Substrate N, where Substrate N may be similar to S2 in the method 200 described above) is loaded into a printer, a colorant to be compensated for is selected, a plurality of patches is printed in the selected colorant at a first time T₁ (e.g., T₁ may be similar to the second time T₂ in the method 200), and the plurality of patches are measured, where the plurality of patches may be similar to the second patches in the method 200 described above).

At block 303, the method 300 determines a change (e.g., Δw) in relative colorant volume as compared to a relative colorant volume of a previous substrate wₙ (e.g., a relative colorant volume of substrate S(N−1) or earlier). In an example, Δw is determined using r_{SN} times wₙ (e.g., similar to r_{S2} times wₙ in the method 200 described above), r_{SN} is a ratio of the relative colorant volumes of previous substrate at two different times and wₙ is a nominal ink volume for each of a plurality of color patches printed at a first time on the previous substrate.

At block 305, the method 300 compensates for colorant drift on substrate N (e.g., SN) for Δw based on compensation data C_{SN} for substrate N, where C_{SN} is similar to C_{S2} in the method 200 described above.

At block 307, the method 300 compensates for colorant drift on substrate N+1 (e.g., S(N+1) for Δw based on compensation data C_{S(N+1)} for substrate N+1.

At block 309, the method 300 compensates for colorant drift on substrate N+2 (e.g., S(N+2)) for Δw based on compensation data C_{S(N+2)} for substrate N+2.

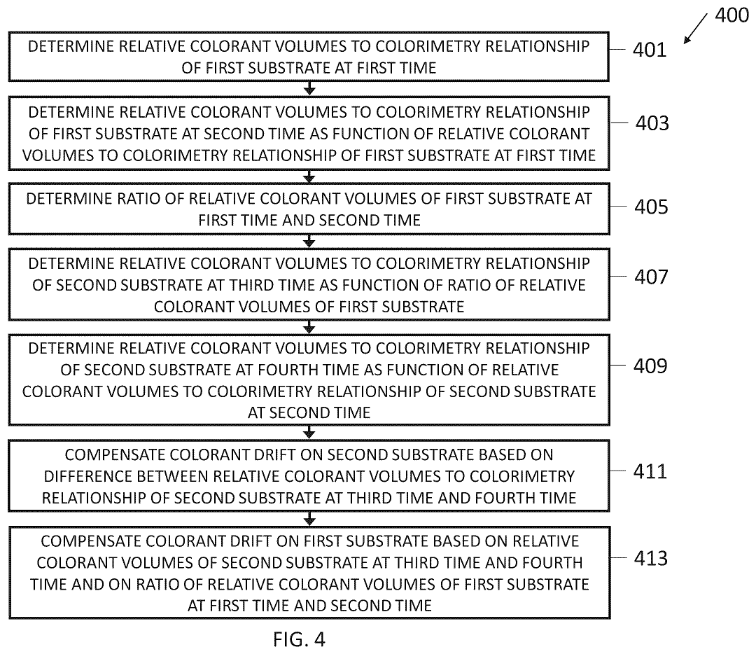

FIG. 4 is a flow chart of an example color calibration method 400 of the present disclosure.

At block 401, the method 400 begins. At block 401, the method 400 determines relative colorant volumes to colorimetry relationship of a first substrate at a first time.

At block 403, the method 400 begins. At block 403, the method 400 determines relative colorant volumes to colorimetry relationship of the first substrate at a second time as a function of the relative colorant volumes to colorimetry relationship of the first substrate at the first time.

At block 405, the method 400 begins. At block 405, the method 400 determines a ratio of the relative colorant volumes of the first substrate at the first time and the second time.

At block 407, the method 400 begins. At block 407, the method 400 determines relative colorant volumes to colorimetry relationship of a second substrate at a third time as a function of the ratio of the relative colorant volumes of the first substrate.

At block 409, the method 400 begins. At block 409, the method 400 determines relative colorant volumes to colorimetry relationship of the second substrate at a fourth time as a function of the relative colorant volumes to colorimetry relationship of the second substrate at the third time.

At block 411, the method 400 begins. At block 411, the method 400 compensates for colorant drift on the second substrate based on a difference between the relative colorant volumes to colorimetry relationship of the second substrate at the third time and the fourth time.

At block 413, compensating colorant drift on the first substrate based on the relative colorant volumes of the second substrate at the third time and the fourth time and on the ratio of the relative colorant volumes of the first substrate at the first time and the second time.

In an example, determining relative colorant volumes to colorimetry relationship of a first substrate at a first time may be accomplished by loading a first instance of a first substrate type S1 into a printer (e.g., a first portion of a roll of a first substrate type, a sheet of the first type of substrate, etc.), selecting a colorant used by the printer to be compensated for, printing a plurality (e.g., 10) of first patches using the selected colorant on the first instance of the first substrate type S1 at a first time T₁ with increasing ink output volumes from patch to patch (commonly referred to an ink ramp, a shade gradient, etc.), assigning an arbitrary (or nominal) value wₙ to each patch in the plurality of first patches and designating the result as a first set w₁ of nominal ink volumes (e.g., w₁=(w₁₁, w₁₂, . . . , w₁₁₀)), measuring an optical characteristic Cₙ of each patch in the plurality of first patches, designating the result as a first set C₁ of optical characteristic measurements (e.g., C₁=(C₁₁, C₁₂, . . . , C₁₁₀)), and associating the values in the first set of nominal colorant volumes (e.g., w₁=(w₁₁, w₁₂, . . . , w₁₁₀)) to corresponding measurements in the first set C₁ of optical characteristic measurements (e.g., C₁=(C₁₁, C₁₂, . . . , C₁₁₀)).

In an example, the colorant output volumes vary from patch to patch in number and/or spacing of dots (e.g., pixels) printed by the printer in the selected colorant (e.g., a second patch has printed thereon 90% of the dots/pixels printed on a first patch and, therefore, 90% of the total colorant volume printed on the first patch; a third patch has printed thereon 80% of the dots/pixels printed on the first patch and, therefore, 80% of the total colorant volume printed on the first patch; . . . ; and a tenth patch has printed thereon 10% of the dots/pixels printed on the first patch and, therefore, 10% of the total colorant volume printed on the first patch).

The arbitrary (or nominal) values wₙ assigned to each patch in the plurality of first patches (e.g., w₁=(w₁₁, w₁₂, . . . , w₁₁₀)) represent a relative, not an actual, total colorant volume on each of the first patches. For example, if 10 first patches were printed and first patch number 2 to 10 have 90% to 10% of the total colorant volume of first patch number 1, respectively, where each subsequent first patch varies by −10% of the first patch number 1 then the nominal colorant volumes (e.g., w₁=(w₁₁, w₁₂, . . . , w₁₁₀)) may be w₁=(1, 0.9, . . . , 0.1).

The measurement may be of lightness (e.g., using the CIELAB color space defined by the International Commission on Illumination (abbreviated CIE). The CIE L* color space may be used to measure the lightness of most ink colors. The CIE b* color space may be used to measure the lightness of yellow ink. A spectrophotometer may be used to measure an optical characteristic of each of the plurality of patches.

C_{S1} is a first substrate characterization of substrate type S1 to which all other measurements of any other substrate type used in the printer may be associated. However, the first substrate characterization C_{S1} may be replaced by a similar substrate characterization of any of the other substrate types which are related, or linked, to C_{S1}. In an example, C_{S1} may be stored in memory as calibration parameters.

In an example, determining relative colorant volumes to colorimetry relationship of the first substrate at a second time as a function of the relative colorant volumes to colorimetry relationship of the first substrate at the first time may be accomplished by positioning a second instance of the first substrate type S1 (e.g., S1₂), printing a plurality of second patches, measuring an optical characteristic Cₙ of each patch in the plurality of second patches, and designating the result as a second set C₂ of optical characteristic measurements (e.g., C₂=(C₂₁, C₂₂, . . . , C₂₁₀)), where the optical characteristic measured is the same as the optical characteristic measured for the first set C₁ of optical characteristic measurements (e.g., C₁=(C₁₁, C₁₂, . . . , C₁₁₀)). The measurement may be of lightness (e.g., using the CIELAB color space defined by the CIE). A spectrophotometer may be used to measure an optical characteristic of each patch.

In an example, the second instance of the first substrate type S1 (e.g., S1₂) may be a new portion (e.g., a roll, a new sheet, etc.) of the first substrate type S1 (e.g., S1₂) to be printed on which has not previously been printed on in the printer. In an example, printing a plurality of second patches may comprise printing a plurality (e.g., 10) of second patches at a second time T₂ with increasing colorant volumes, where the plurality of second patches equals the plurality of first patches, and where the number of printer outputs (e.g., dots or pixels) per patch in the plurality of second patches matches the number, but not necessarily the colorant volume, of printer outputs (e.g., dots or pixels) per patch in the plurality of first patches, since the printer's colorant volume per output (e.g., dot or pixel) may have changed over time (e.g., colorant accumulating in a print nozzle may cause a colorant volume per dot in the nozzle to decline as compared to the nozzle when the printer was initially calibrated).

In an example, the first set C₁ of optical characteristic measurements (e.g., C₁=(C₁₁, C₁₂, . . . , C₁₁₀)) is compared to the second set C₂ of optical characteristic measurements (e.g., C₂=(C₂₁, C₂₂, . . . , C₂₁₀)) to determine which measurements in the second set C₂ of optical characteristic measurements (e.g., C₂=(C₂₁, C₂₂, . . . , C₂₁₀)) are approximately equal to the measurements in the first set C₁ of optical characteristic measurements (e.g., C₁=(C₁₁, C₁₂, . . . , C₁₁₀)). For example, the measurements of the first set C₁ of optical characteristic measurements (e.g., C₁=(C₁₁, C₁₂, . . . , C₁₁₀)) and the second set C₂ of optical characteristic measurements (e.g., C₂=(C₂₁, C₂₂, . . . , C₂₁₀)) both progress from values indicating darker shades of colorant to values indicating lighter shades of colorant. However, since colorant volume output by the printer during the printing of the plurality of second patches at the second time T₂ may have diminished since the colorant volume output by the printer during the printing of the plurality of first patches at the first time T₁, each patch in the plurality of second patches may be lighter than the corresponding patch in the plurality of first patches. Thus, a measurement value in the second set C₂ of optical characteristic measurements (e.g., C₂=(C₂₁, C₂₂, . . . , C₂₁₀)) may match a measurement value in the first set C₁ of optical characteristic measurements (e.g., C₁=(C₁₁, C₁₂, . . . , C₁₁₀)) associated with a patch position that is further right (e.g., lighter) in the plurality of first patches (e.g., C₂₁ may be approximately equal to C₁₂ or a further-right patch in the plurality of first patches).

In an example, for each measurement in the second set of optical characteristic measurements (e.g., C₂=(C₂₁, C₂₂, . . . , C₂₁₀)) that is approximately equal to a measurement in the first set of optical characteristic measurements (e.g., C₁=(C₁₁, C₁₂, . . . , C₁₁₀)), the value in the first set of nominal colorant volumes (e.g., w₁=(w₁₁, w₁₂, . . . , w₁₁₀)) may be assigned to the patch in the plurality of second patches for which the optical characteristic measurement of the patch in the plurality of second patches is approximately equal to the measurement of the optical characteristic measurement of the patch in the plurality of first patches. For example, if (C₁₁, C₁₂, . . . , C₁₁₀)=(10, 9, 8, 7, 6, 5, 4, 3, 2, 1) and (C₂₁, C₂₂, . . . , C₂₁₀)=(9, 8, 7, 6, 5, 4, 3, 2, 1, 0) then C₂₁=C₁₂, C₂₂=C₁₃, C₂₃=C₁₄, C₂₄=C₁₅, C₂₅=C₁₆, C₂₆=C₁₇, C₂₇=C₁₈, C₂₈=C₁₉, and C₂₉=C₁₁₀. For example, the colorant volume values for the plurality of second patches may be designated w₂=(w₂₁, w₂₂, . . . , w₂₉, w₂₁₀). Then, in the example, the first nine patches of the plurality of second patches are assigned the last nine colorant volume values of the plurality of first patches, respectively (e.g. (w₂₁, w₂₂, . . . , w₂₉)=(w₁₂, w₁₃, . . . , w₁₉)). In another example, interpolation may be used. For example, if C₁₁=10, C₁₂=9 and it is needed to find volume for C₂₁=9.5 then a linear interpolation is calculated between w₁₁ and w₁₂. In other words, finding a direct match between data sets for different substrates may not be very common, but interpolation may be used to determine colorant volumes for specific colorimetries.

In an example, determining a ratio (e.g., r_{S2}) of the relative colorant volumes of the first substrate at the first time and the second time may be accomplished by dividing a relative colorant volume value of at least one patch in the plurality of first patches by the relative colorant volume value of a corresponding patch in the plurality of second patches that was assigned a colorant volume value. In the example above, there are nine possible r_{S2} ratios (e.g., w₂₁/w₁₁, w₂₂/w₁₂, w₂₃/w₁₃, w₂₄/w₁₄, w₂₅/w₁₅, w₂₆/w₁₆, w₂₇/w₁₇, w₂₈/w₁₈, w₂₉/w₁₉). In this example, a ratio cannot be determined involving w₂₁₀, because w₂₁₀ did not have an ink volume value assigned to it. One of the r_{S2} ratios may be selected (e.g., a highest value, a lowest value, a median value, etc.) or a user-definable function of a plurality of the r_{S2} ratios may be determined (e.g., an average, a standard deviation, etc.).

In an example, determining relative colorant volumes to colorimetry relationship of a second substrate at a third time as a function of the ratio of the relative colorant volumes of the first substrate may be accomplished by unloading the second instance S1₂ of the first substrate type S1 from the printer, loading a second substrate type S2 into the printer, printing a plurality (e.g., 10) of third color patches on the second substrate S2 at a third time T₃ with increasing ink output volumes, where the plurality of third patches equals the plurality of first patches, and where the number of printer outputs (e.g., dots or pixels) per patch in the plurality of third patches matches the number, but not necessarily the colorant output volume, of printer outputs (e.g., dots or pixels) per patch in the plurality of first patches, since the printer's ink output volume per output (e.g., dot or pixel) may have changed over time (e.g., colorant accumulating in a print nozzle may cause a colorant volume per dot in the nozzle to decline as compared to the nozzle when the printer was initially calibrated), wherein the third time T₃ is sufficient close in time to the second time T₂ that the total colorant volume on each of the plurality of third patches matches the total colorant volume on corresponding patches in the plurality of second patches.

In an example, an optical characteristic Cₙ of each patch in the second plurality of color patches are measured and the result is designated as a third set C₃ of optical characteristic measurements (e.g., C₃=(C₃₁, C₃₂, . . . , C₃₁₀)), where the optical characteristic measured is the same as the optical characteristic measured for the first set C₁ of optical characteristic measurements (e.g., C₁=(C₁₁, C₁₂, . . . , C₁₁₀)). The measurement may be of lightness (e.g., using the CIELAB color space defined by the CIE). A spectrophotometer may be used to measure an optical characteristic of each patch.

In an example, ink volume values w₃=(w₃₁, w₃₂, . . . , w₃₁₀) that correspond to the third set C₃ of optical characteristic measurements (e.g., C₃=(C₃₁, C₃₂, . . . , C₃₁₀)) are determined as w₃×r_{S2}=(w₁₁×r_{S2}, w₁₂×r_{S2}, . . . , w₁₁₀×r_{S2}) and the third set w₃ of ink volumes (e.g., w₃=(w₃₁, w₃₂, . . . , w₃₁₀)) and the third set C₃ of optical characteristic measurements (e.g., C₃=(C₃₁, C₃₂, . . . , C₃₁₀)) are designated as a second substrate characterization data set C_{S2} for substrate type S2. C_{S2} may replace the first substrate characterization set C_{S1} to which all other measurements of any other substrate type used in the printer may be associated. In addition, the second characterization set C_{S2} may be further be replaced by a similar characterization set data of any of the other substrate types. Thus, substrate type S1 and substrate type S2 are both characterized in terms of their colorimetry to colorant volumes relationship, without having used a reference substrate or required additional substrate changes. In addition, the substrate characterization data sets are linked (or chained) together, where any of them may be used to calibrate all of the substrate types.

In an example, determining relative colorant volumes to colorimetry relationship of the second substrate at a fourth time as a function of the relative colorant volumes to colorimetry relationship of the second substrate at the third time may be accomplished by positioning a second instance of the second substrate type S2 (e.g., S2₂), printing a plurality of fourth patches, measuring an optical characteristic Cₙ of each patch in the plurality of fourth patches, and designating the result as a fourth set C₄ of optical characteristic measurements (e.g., C₄=(C₄₁, C₄₂, . . . , C₄₁₀)), where the optical characteristic measured is the same as the optical characteristic measured for the first set C₁ of optical characteristic measurements (e.g., C₁=(C₁₁, C₁₂, . . . , C₁₁₀)). The measurement may be of lightness (e.g., using the CIELAB color space defined by the CIE). A spectrophotometer may be used to measure an optical characteristic of each patch.

In an example, the second instance of the second substrate type S2 (e.g., S2₂) may be a new portion (e.g., a roll, a new sheet, etc.) of the second substrate type S2 to be printed on which has not previously been printed on in the printer. In an example, printing a plurality of fourth patches may comprise printing a plurality (e.g., 10) of fourth patches at a fourth time T₄ with increasing colorant volumes, where the plurality of fourth patches equals the plurality of third patches, and where the number of printer outputs (e.g., dots or pixels) per patch in the plurality of fourth patches matches the number, but not necessarily the colorant volume, of printer outputs (e.g., dots or pixels) per patch in the plurality of third patches, since the printer's colorant volume per output (e.g., dot or pixel) may have changed over time (e.g., colorant accumulating in a print nozzle may cause a colorant volume per dot in the nozzle to decline as compared to the nozzle when the printer printed the plurality of third patches).

In an example, the third set C₃ of optical characteristic measurements (e.g., C₃=(C₃₁, C₃₂, . . . , C₃₁₀)) is compared to the fourth set C₄ of optical characteristic measurements (e.g., C₄=(C₄₁, C₄₂, . . . , C₄₁₀)) to determine which measurements in the fourth set C₄ of optical characteristic measurements (e.g., C₄=(C₄₁, C₄₂, . . . , C₄₁₀)) are approximately equal to the measurements in the third set C₃ of optical characteristic measurements (e.g., C₃=(C₃₁, C₃₂, . . . , C₃₁₀)). For example, the measurements of the third set C₃ of optical characteristic measurements (e.g., C₃=(C₃₁, C₃₂, . . . , C₃₁₀)) and the fourth set C₄ of optical characteristic measurements (e.g., C₄=(C₄₁, C₄₂, . . . , C₄₁₀)) both progress from values indicating darker shades of colorant to values indicating lighter shades of colorant. However, since colorant volume output by the printer during the printing of the plurality of fourth patches at the fourth time T₄ may have diminished since the colorant volume output by the printer during the printing of the plurality of third patches at the third time T₃, each patch in the plurality of fourth patches may be lighter than the corresponding patch in the plurality of third patches. Thus, a measurement value in the fourth set C₄ of optical characteristic measurements (e.g., C₄=(C₄₁, C₄₂, . . . , C₄₁₀)) may match a measurement value in the third set C₃ of optical characteristic measurements (e.g., C₃=(C₃₁, C₃₂, . . . , C₃₁₀)) associated with a patch position that is further right (e.g., lighter) in the plurality of third patches (e.g., C₄₁ may be approximately equal to C₃₂ or a further-right patch in the plurality of third patches).

In an example, for each measurement in the fourth set of optical characteristic measurements (e.g., C₄=(C₄₁, C₄₂, . . . , C₄₁₀)) that is approximately equal to a measurement in the third set of optical characteristic measurements (e.g., C₃=(C₃₁, C₃₂, . . . , C₃₁₀)), the value in the third set of nominal colorant volumes (e.g., w₃=(w₃₁, w₃₂, . . . , w₃₁₀)) may be assigned to the patch in the plurality of fourth patches for which the optical characteristic measurement of the patch in the plurality of fourth patches is approximately equal to the measurement of the optical characteristic measurement of the patch in the plurality of third patches. For example, if (C₃₁, C₃₂, . . . , C₃₁₀)=(10, 9, 8, 7, 6, 5, 4, 3, 2, 1) and (C₄₁, C₄₂, . . . , C₄₁₀)=(9, 8, 7, 6, 5, 4, 3, 2, 1, 0) then C₄₁=C₃₂, C₄₂=C₃, C₄₃=C₃₄, C₄=C₃₅, C₄₅=C₃₆, C₄₆=C₃₇, C₄₇=C₃₈, C₄₈=C₃₉, and C₄₉=C₃₁₀. For example, the colorant volume values for the plurality of fourth patches may be designated w₄=(w₄₁, w₄₂, . . . , w₄₉, w₄₁₀). Then, in the example, the first nine patches of the plurality of fourth patches are assigned the last nine colorant volume values of the plurality of third patches, respectively (e.g. (w₄₁, w₄₂, . . . , w₄₉)=(w₃₂, w₃₃, . . . , w₃₉)).

For subsequent substrates, the method described above is repeated to compare colorant measured for a substrate SN currently loaded into the printer at a time T(X−1) and a later time T(X) and compute a relative colorant volume ratio r_{SN}, where r_{SN} is a ratio between a relative colorant volume of currently loaded substrate SN and a colorant volume at which a subsequently loaded substrate S(N+1) will first be measured.

Colorant measurements of the subsequently loaded substrate S(N+1), are associated with r_{SN}*wₙ ink volumes. This results in having the subsequently loaded substrate S(N+1) characterized in terms of its colorimetry to relative colorant volumes relationship (C_{SN}), without having used a reference substrate or requiring additional substrate changes. In addition, the relative colorant volumes link back to the first nominal colorant volumes.

With each substrate having a characterization relative to the same, nominal colorant volumes set at the first substrate S1, when a colorant volume change Δw is determined for one of the substrates, the colorant volume change Δw may be propagated to all other substrates. That is, using r_{SN} for each substrate allows for Δw to be used to compute what colorants would have been measured for each of the N substrates since the new colorant volumes will be known (i.e., the per-substrate references (C_{SN}) multiplied by Δw) and the corresponding colorants (i.e., from the colorant volume to colorant characterization done when each of the substrates was first used).

The above approach removes a major usability obstacle to transferring colorant compensation between substrates and reduces the need for using a dedicated reference substrate. The present disclosure may be extended by, e.g., allowing for a substrate to be re-characterized using the previous substrate (i.e., instead of the characterization having to come from its first use), or by adding extrapolation to the colorant volume to colorant characterization, in case colorant volumes exceed those used when a substrate is first characterized (this may be done using standard one dimensional (1D) extrapolation techniques, such as fitting polynomials to the available data). It is also possible to be more selective about when to perform chained colorant compensation (i.e., compensating the loaded substrate before unloading it and loading the next one), which are done when the next substrate is one that has not been loaded before and where the chained process establishes the r_{S} factor of the new substrate.

Since the overall number of measurement events involved in chained colorant compensation is reduced, the negative contribution of measurement noise is also reduced. Furthermore, since the colorant volumes are computed on up-to-date measurements from both substrates S1 and S2 at the time of compensation, media variation (even for nominally the same media) is also taken into account.

The present disclosure enables a transfer of colorant compensation between substrates by linking, or chaining, colorant characterization information of the substrates together. As a result, each newly-loaded substrate is loaded for a known colorant volume and the colorant characterizations of all substrates are obtained in the same domain, which allows for colorant volume changes to be directly applied to all of the substrates.

The present disclosure enables savings in the areas of colorant, substrate, time, and operator attention. The present disclosure also eliminates a need for a reference substrate.

FIG. 5 is a schematic of a colorant compensation system 500 of the present disclosure. In an example, the colorant compensation system 500 may include the printer 501, the spectrophotometer 505 connected to the printer 501, and a processor 503 connected to the printer 501 and the spectrophotometer 505. In an example, the colorant compensation system 500 characterizes substrates and compensates for color drift. In an example,

In an example, the printer 501 prints first patches on a first substrate at a first time, second patches on a first substrate at a second time, third patches on a second substrate at a third time, and fourth patches on the second substrate at a fourth time.

In an example, the spectrophotometer 505 further comprises measuring the first patches, the second patches, the third patches, and the fourth patches.

In an example, the processor 503 determines relative colorant volumes to colorimetry relationship of the first substrate at the first time, determines relative colorant volumes to colorimetry relationship of the first substrate at the second time as a function of the relative colorant volumes to colorimetry relationship of the first substrate at the first time, determines a ratio of the relative colorant volumes of the first substrate at the first time and the second time, determines relative colorant volumes to colorimetry relationship of the second substrate at the third time as a function of the ratio of the relative colorant volumes of the first substrate, determines relative colorant volumes to colorimetry relationship of the second substrate at the fourth time as a function of the relative colorant volumes to colorimetry relationship of the second substrate at the third time, and compensates for colorant drift on the second substrate based on a difference between the relative colorant volumes to colorimetry relationship of the second substrate at the third time and the fourth time.

In an example, the processor 503 assigns nominal values representing colorant volume to the first patches, compares the measurements of the second patches to the measurements of the first parameters, assigns the colorant volumes of the first patches to the second patches that match the measurements of first patches, respectively, determines at least one ratio of colorant volume of a first patch to that of a corresponding second patch, assigns relative colorant volumes to the second substrate that are equal to the relative colorant volumes of the first substrate at the first time times the ratio of the relative colorant volumes of the first substrate, and determines at least one ratio of colorant volume of a third patch to that of a corresponding fourth patch.

Variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A method of colorant compensation using relative colorant volumes, comprising:
determining relative colorant volumes to colorimetry relationship of a first substrate at a first time;
determining relative colorant volumes to colorimetry relationship of the first substrate at a second time as a function of the relative colorant volumes to colorimetry relationship of the first substrate at the first time;
determining a ratio of the relative colorant volumes of the first substrate at the first time and the second time;
determining relative colorant volumes to colorimetry relationship of a second substrate at a third time as a function of the ratio of the relative colorant volumes of the first substrate;
determining relative colorant volumes to colorimetry relationship of the second substrate at a fourth time as a function of the relative colorant volumes to colorimetry relationship of the second substrate at the third time;
compensating colorant drift on the second substrate based on a difference between the relative colorant volumes to colorimetry relationship of the second substrate at the third time and the fourth time;
and
compensating colorant drift on the first substrate based on the relative colorant volumes of the second substrate at the third time and the fourth time and on the ratio of the relative colorant volumes of the first substrate at the first time and the second time.

2. The method of claim 1, wherein determining the relative colorant volumes to colorimetry relationship of the first substrate at the first time comprises:
printing first patches on the first substrate;
measuring the first patches; and
assigning nominal values representing colorant volume to the first patches.

3. The method of claim 2, wherein determining the relative colorant volumes to colorimetry relationship of the first substrate at the second time comprises:
printing second patches on the second substrate;
measuring the second patches;
comparing the measurements of the second patches to the measurements of the first patches; and
assigning the colorant volumes of the first patches to the second patches that match the measurements of first patches, respectively.

4. The method of claim 1, wherein determine the ratio of the relative colorant volumes of the first substrate at the first time and the second time comprises determining at least one ratio of colorant volume of a first patch to that of a corresponding second patch.

5. The method of claim 1, wherein determining the relative colorant volumes to colorimetry relationship of the second substrate at the third time comprises:
printing third patches on the second substrate;
measuring the third patches; and
assigning relative colorant volumes to the second substrate that are equal to the relative colorant volumes of the first substrate at the first time times the ratio of the relative colorant volumes of the first substrate.

6. The method of claim 1, wherein determining the relative colorant volumes to colorimetry relationship of the second substrate at the fourth time comprises determining at least one ratio of colorant volume of a third patch to that of a corresponding fourth patch.

7. The method of claim 2, wherein the first patches comprise a plurality of patches, the plurality of patches having colorant volume deposited thereon that decreases from patch to patch.

8. The method of claim 2, wherein measuring the first patches comprises measuring for lightness using a CIELAB color space defined by an International Commission on Illumination (CIE).

9. The method of claim 1, wherein the ratio of the relative colorant volumes of the first substrate comprises one of a highest value, a lowest value, and a median value of one ratio of colorant volumes of a second patch of the first substrate and a corresponding first patch of the first substrate.

10. The method of claim 1, wherein the ratio of relative colorant volume comprises one of an average and a standard deviation of a plurality of ratios of colorant volume of a second patch of the first substrate to that of a corresponding first patch of the first substrate.

11. A system for colorant compensation using relative colorant volumes, comprising:
a printer;
a spectrophotometer connected to the printer; and
a processor connected to the printer and the spectrophotometer to determine relative colorant volumes to colorimetry relationship of a first substrate at a first time, determine relative colorant volumes to colorimetry relationship of the first substrate at a second time as a function of the relative colorant volumes to colorimetry relationship of the first substrate at the first time, determine a ratio of the relative colorant volumes of the first substrate at the first time and the second time, determine relative colorant volumes to colorimetry relationship of a second substrate at a third time as a function of the ratio of the relative colorant volumes of the first substrate, determine relative colorant volumes to colorimetry relationship of the second substrate at a fourth time as a function of the relative colorant volumes to colorimetry relationship of the second substrate at the third time, compensate for colorant drift on the second substrate based on a difference between the relative colorant volumes to colorimetry relationship of the second substrate at the third time and the fourth time, and compensate for colorant drift on the first substrate based on the relative colorant volumes of the second substrate at the third time and the fourth time and on the ratio of the relative colorant volumes of the first substrate at the first time and the second time.

12. The system of claim 11, wherein the printer further comprises printing first patches on the first substrate at the first time, second patches on the first substrate at the second time, third patches on the second substrate at the third time, and fourth patches on the second substrate at the fourth time.

13. The system of claim 12, wherein the spectrophotometer further comprises measuring the first patches, the second patches, the third patches, and the fourth patches.

14. The system of claim 12, wherein the processor further comprises assigning nominal values representing colorant volume to the first patches, comparing the measurements of the second patches to the measurements of the first patches, assigning the colorant volumes of the first patches to the second patches that match the measurements of first patches, respectively, determining at least one ratio of colorant volume of a first patch to that of a corresponding second patch, assigning relative colorant volumes to the second substrate that are equal to the relative colorant volumes of the first substrate at the first time times the ratio of the relative colorant volumes of the first substrate, and determining at least one ratio of colorant volume of a third patch to that of a corresponding fourth patch.

15. The system of claim 11, wherein the processor further comprises determining the ratio of the relative colorant volumes of the first substrate at the first time and the second time comprises determining at least one ratio of colorant volume of a first patch to that of a corresponding second patch.
